(19) United States
(12) Patent Application Publication
(10) Pub. No.: US 2006/0079640 A1
(43) Pub. Date: Apr. 13, 2006

(54) Adhesive composition for dermal patch and production process thereof

(76) Inventor: Tetsuya Ishii, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/532,873

(22) PCT Filed: Oct. 29, 2003
(86) PCT No.: PCT/JP03/13836

§ 371 Date: Apr. 28, 2005

Related U.S. Application Data
(60) Provisional application No. 60/425,397, filed on Nov. 12, 2002.

(30) Foreign Application Priority Data
Oct. 30, 2002 (JP) 2002-315257

(51) Int. Cl. C08L 53/00; C08L 33/02; C08F 20/06

(52) U.S. Cl. 525/88; 525/221; 526/317.1

(57) ABSTRACT

An adhesive composition for dermal patches, comprising (A) a (meth)acrylic acid-base polymer having repeating units represented by formulae (1) and (2): (wherein R¹ and R² each independently represents a hydrogen atom or a methyl group and M represents NH₄⁺ or an alkali metal) with the ratio of (1)/(2) being in a range of 100/0 to 90/10 (by mol), (B) water, (C) a polyhydric alcohol and (D) an aluminum compound, with the content of (B) water being from 5 to 30 mass %; and a production process thereof. The adhesive composition for dermal patch of the present invention can contain a large amount of polyhydric alcohol between skeletons of the adhesive layer and forms a stable between skeletons of the adhesive layer and forms a stable base material free from syneresis of the polyhydric alcohol. Furthermore, the dermal patch using the adhesive composition for dermal patch of the present invention is excellent in the release property and adherence and has high safety.

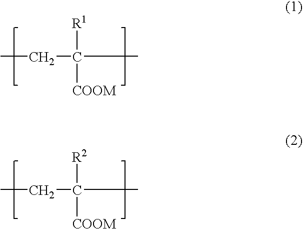

### CROSS-REFERENCE TO THE RELATED APPLICATIONS

This is an application filed pursuant to 35 U.S.C. Section 111(a) with claiming the benefit of U.S. Provisional application Ser. No. 60/426,397 filed Nov. 15, 2002, under the provision of 35 U.S.C. Section 111(b), pursuant to 35 U.S.C. Section 119(e)(1).

### TECHNICAL FIELD

The present invention relates to an adhesive composition for preparation for dermal patch, more specifically, the present invention relates to an adhesive composition to be contained in preparation for transdermal patches with excellent release property, good adherence and high safety, which is used as a percutaneous absorption-type preparation for external application and which is obtained by dispersing or dissolving a (meth)acrylic acid-base polymer and a percutaneous absorptive medicament in an aqueous polyhydric alcohol solution, and also relates to a production process thereof.

### BACKGROUND ART

In preparations for oral cavity mucosa, percutaneous absorption and the like, which are used for medical treatments, alcohols such as polyhydric alcohol are recently verified to enhance the solubility and percutaneous absorption of a medicament. Based on this finding, studies are being made to incorporate an alcohol in a high concentration into agent for dermal patches.

Dermal patch drug delivery systems are generally classified into two types, that is, a non-aqueous preparation such as plaster and tape and a hydrous type such as poultice. As adhesive composition of the non-aqueous preparation, acryl-base or rubber-base adhesives are used, however, despite good percutaneous absorption of a medicament, the irritation to skin is strong due to their high adherence and these cannot be used in a medicinal patch which must be repeatedly attached to the skin. Furthermore, these adhesives have no hydrophilicity and are readily stripped off due to sweat or body fluid to cause a gap between the skin and the patch, giving rise to reduction in the absorption of medicament. The acryl-base polymer still has a problem of toxicity of the residual monomer and in particular, when fixed to skin, the residual monomer gives skin irritation (see, for example, Nippon Secchaku Gakkai Shi (Journal of the Adhesion Society of Japan), 27, 526 (1991)).

On the other hand, the hydrous preparation is generally constituted by using a natural water-soluble polymer such as traganth gum, acacia, carrageenan, duran gum, sodium alginate, mannan and gelatin, or a synthetic polymer such as polyacrylate, polymethacrylate, polyvinyl alcohol and polyacrylamide, and blending therewith a moisture-holding agent such as polyhydric alcohol. These base materials of the adhesive are hydrophilic and therefore, these are less irritating to skin and suitable for long-term application. However, their adherence is poor and since many of medicaments which are absorbed through skin are lipophilic, the medicament is hardly dissolved in a hydrous preparation having a large water content, resulting in poor absorption. Furthermore, in the case of medicaments which are readily hydrolyzed, the stability of medicament can be hardly ensured with time.

In order to avoid such problems, for example, a technique of dissolving a polyacrylic acid in a gel comprising polyhydric alcohol and crosslinking it by magnesium aluminate metasilicate has been proposed in JP-A-4-178323 (the term “JP-A” as used herein means an “unexamined published Japanese patent application”).

The polyacrylic acid is hydrophilic and estimated to be less irritating. However, since this gel contains substantially no water, the crosslinking reaction of aluminum and carboxyl group scarcely proceeds and sticking or so-called “glue residue” to skin is caused to give an extremely bad feeling on use. Furthermore, although the polyacrylic acid dissolves in glycerin, its low thickening property cannot contribute to improving adherence.

JP-A-6-128151 describes a plaster base material comprising a monovalent salt of polyacrylic acid represented by a specific formula and/or polymethacrylic acid represented by a specific formula, polyacrylic acid and/or polymethacrylic acid, a predetermined amount of an aluminum salt and an alcohol. However, the polymer described here is low in the affinity for alcohol and as the alcohol concentration increases, the polymer aggregates and precipitates, as a result, viscosity and in turn adherence are not expressed.

### DISCLOSURE OF INVENTION

An object of the present invention is to solve those problems in conventional techniques and provide an adhesive composition for dermal patch, which ensures good adherence to an adherend, less irritation to skin, no generation of liquid syneresis, and high percutaneous absorption of a medicament, and of which preparation process is simple enough.

As a result of extensive investigations by taking account of those problems, the present inventors have found that when a specific (meth)acrylic acid-base polymer or a copolymer thereof and a polyhydric alcohol are used as main components, the water content in the adhesive for dermal patch can be reduced to substantially 30 mass % or less and a transdermal patch using the adhesive composition exhibits excellent percutaneous absorption.

That is, the present invention relates to the following adhesive composition for dermal patch and a production process thereof.

1. An adhesive composition for dermal patch, comprising (A) a (meth)acrylic acid-base polymer having repeating units represented by formulae (1) and (2): 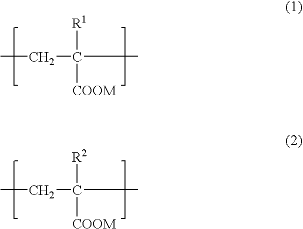
wherein R¹ and R² each independently represents a hydrogen atom or a methyl group and M represents NH₄⁺ or an alkali metal,
with a ratio of (1)/(2) being in a range from 100/0 to 90/10 (by mol), (B) water, (C) a polyhydric alcohol and (D) an aluminum compound, with the content of (B) water being from 5 to 30 mass %.

2. The adhesive composition for dermal patch as described in 1 above, wherein (A)the (meth)acrylic acid-base polymer having repeating units represented by formulae (1) and (2) has a viscosity of 400 mPa·s or more in 0.2 mass % aqueous solution. 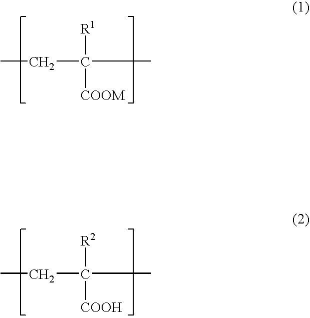
(All the symbols have the same meaning as defined in 1 above.)

3. The adhesive composition for dermal patch as described in 1 above, wherein the polyhydric alcohol is a trivalent or of a higher valence.

4. The adhesive composition for dermal patch as described in 3 above, wherein the polyhydric alcohol is glycerin.

5. The adhesive composition for dermal patch as described in 1 above, wherein the polyhydric alcohol content is from 40 to 94.5 mass % based on the entire amount of the composition.

6. The adhesive composition for dermal patch as described in 1 above, wherein a water-soluble aluminum compound and a magnesium hydroxide aluminum hydroxide co-precipitate are used in combination as the aluminum compound.

7. The adhesive composition for dermal patch as described in 1 above, wherein the aluminum compound content is from 0.01 to 20 mass % based on the entire amount of the composition.

8. The adhesive composition for dermal patch as described in 1, which further comprises (E) a polymer compound having high affinity for the polyhydric alcohol.

9. The adhesive composition for dermal patch as described in 8 above, wherein (E) the polymer compound having high affinity for the polyhydric alcohol is at least one member selected from the group consisting of a carboxyvinyl polymer and an N-vinylacetamide-sodium acrylate copolymer.

10. The adhesive composition for dermal patch as described in 8 or 9 above, wherein the content of the polymer compound having high affinity for the polyhydric alcohol is from 0.01 to 20 mass % based on the entire amount of the composition.

11. The adhesive composition for dermal patch as described in 1 to 10, which comprises diclofenac sodium as a pharmaceutically active ingredient.

12. The adhesive composition for dermal patch as described in 1 to 10, which comprises capsaicin as a pharmaceutically active ingredient.

13. A process for producing an adhesive composition for dermal patch, the adhesive composition comprising, as essential components, (A) a (meth)acrylic acid-base polymer having repeating units represented by formulae (1) and (2): 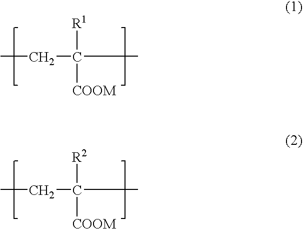
(All the symbols have the same meaning as in 1 above.) with a ratio of (1)/(2) being in a range from 100/0 to 90/10 (by mol), (B) water, (C) a polyhydric alcohol and (D) an aluminum compound and comprising, if desired, (E) a polymer compound having high affinity for the polyhydric alcohol, with the content of (B) water being from 5 to 30 mass % above, wherein (A) the (meth)acrylic acid-base polymer and a solution of (C) the polyhydric alcohol in (B) water are mixed to give a water concentration of 50% or more in the total mass thereof and then the remaining ingredients ((C) the residual polyhydric alcohol, (D) the aluminum compound and if desired, (E) the polymer compound) are added and mixed to adjust the water concentration to a range of 5 to 30%.

### DETAILED DESCRIPTION OF INVENTION

The present invention is described in detail below.

The present inventors have observed the solubility of a polyacrylic acid, a polyacrylic acid partially neutralized compound (acrylic acid-acrylate copolymer) and a polyacrylate in a highly concentrated aqueous solution of polyhydric alcohol. The polyacrylic acid dissolves in the highly concentrated aqueous solution of polyhydric alcohol but due to high aggregation property of the polymer itself, the solution becomes slightly turbid in white. The polyacrylic acid partial neutralized compound is examined on the solubility by changing the copolymerization ratio of acrylic acid and acrylate and as expected, as the content of acrylic acid having high affinity for alcohol increases, higher solubility is exhibited. However, surprisingly, it has been found that when the acrylic acid content becomes 10 mol % or less, this copolymer exhibits conversely good solubility in the highly concentrated aqueous solution of polyhydric alcohol. The present invention has been accomplished based on this finding. The reason why the copolymer containing a large amount of acrylate exhibits high solubility is not known, however, it is assumed that the salt dissociates if water is present even in a small amount, that is, many carboxylates come to exist, and thereby the affinity for polyhydric alcohol is elevated. On the other hand, if the content of the acrylic acid or methacrylic acid (hereinafter, “acrylic acid or methacrylic acid” is collectively called as “(meth)acrylic acid”) increases, the number of free carboxyl groups increases in the polymer molecule chain and the polymer aggregates (clumps), as a result, the salt is prevented from dissociation and the amount of carboxylate decreases.

Furthermore, the (meth)acrylic acid-base polymer as the base material is water-soluble and therefore, the adhesive layer is enhanced in the hydrophilicity and absorbs moisture secreted on the skin surface, so that the adherence of the dermal patch to the skin can be maintained and a satisfactory pharmaceutical effect can be fully obtained. Furthermore, an equilibrium state is established with the water vapor in the surrounding and the skin can be prevented from sweaty conditions or rash in skin.

The adhesive composition for dermal patch obtained in the present invention has excellent properties and therefore, can be applied to various uses described below.

(I) Medical Products:

For example, medication agents for transdermal patch such as preparation for percutaneous absorption or permucosal absorption.

(II) Medical Tools:

For example, products for cooling fevered area, wound care kits, pads for medical treatments, surgical liquid absorber and burn care kits.

(III) Cosmetics and Quasi Drugs:

For example, packs, sun care kits, facial masks, and anti-acne products.

The adhesive composition for dermal patch of the present invention comprises, as essential components, a (meth)acrylic acid-base polymer (Component A), water (Component B), a polyhydric alcohol (Component C) and an aluminum compound (Component D), and the amount of water is low and substantially from 5 to 30 mass %.

The (meth)acrylic acid-base polymer (Component A) for use in the present invention is preferably used in an amount of 0.5 to 30 mass % (hereinafter simply referred to as “%”), more preferably from 2 to 20%, based on the entire amount of Components A to C. If the amount used is less than 0.5%, syneresis (liquid separation) is generated from the gel body rendering the adhesive layer inhomogeneous. If the amount of component A exceeds 30%, the viscosity of sol at the time of shaping increases, and the shaping or the mixing of other components becomes difficult.

Specific examples of the (meth)acrylic acid-base polymer where the repeating units constituting Component (A) are represented by formulae (1) and (2): 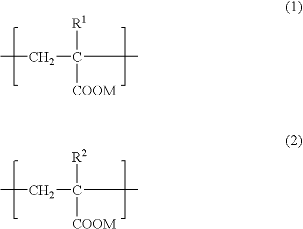
(wherein R¹ and R² each independently represent a hydrogen atom or a methyl group and M represents NH₄⁺ or an alkali metal) with the ratio of (1)/(2) being in a range from 100/0 to 90/10 (by mol) include:

(1) homopolymers of an alkali metal salt (e.g., sodium salt, potassium salt), an ammonium salt or the like of acrylic acid or methacrylic acid,

(2) copolymers of an acrylic acid and an alkali metal salt (e.g., sodium salt, potassium salt), an ammonium salt or the like of acrylic acid or methacrylic acid, and

(3) copolymers of a methacrylic acid and an alkali metal salt (e.g., sodium salt, potassium salt), an ammonium salt or the like of acrylic acid or methacrylic acid.

It is preferable that (meth)acrylic acid used in the present invention have a viscosity of 400 mPa·s or more in 0.2 mass % aqueous solution. If the viscosity is less than 400 mPa·s, syneresis (liquid separation) is generated from the gel body, rendering the adhesive layer inhomogeneous.

In the adhesive composition for dermal patch of the present invention, in addition to the (meth)acrylic acid-base polymer as Component (A), a (meth)acrylic acid-base polymer where the molar ratio of (1)/(2) is out of the above-described range (namely, the molar ratio of (meth)acrylic acid exceeds 10 mol %) may be added as far as the addition amount does not exceed the amount of Component (A) and does not exceed 5% based on the entire mass of the composition.

Water is added so as to increase the solubility of the (meth)acrylic acid-base polymer and thereby create a thickened state. The amount of water added is from 5 to 30%. If the amount added is less than 5%, the solubility of the (meth)acrylic acid-base polymer in the polyhydric alcohol decreases and the thickening effect is not sufficiently obtained, as a result, there occurs a so-called “glue residue” phenomenon that the polymer remains on the release paper or skin surface to which the dermal patch is applied, or so-called “back-through” phenomenon that the adhesive composition for dermal patch evaporates out through the support. On the other hand, if the amount added exceeds 30%, the solubility of a medicament in the composition becomes worse and the diffusion rate of the medicament decreases, resulting in less absorption into the skin.

The polyhydric alcohol (C) is blended for the purpose of increasing the solubility and activity of a medicament in the adhesive composition for dermal patch and thereby enhancing the migration into the skin. Examples of the polyhydric alcohol include, but are not limited to, ethylene glycol, propylene glycol, 1,3-butylene glycol, diethylene glycol, triethylene glycol, 1,4-butylene glycol (dihydric alcohols), glycerin, trioxyisobutane (trihydric alcohols), erythritol, pentaerythritol (tetrahydric alcohols), xylitol, adnitol (pentahydric alcohols), allodulcitol, sorbitol, liquid sorbitol, mannitol (hexahydric alcohols), polyglycerin and dipropylene glycol. Among these, glycerin is preferred in view of its safety and affinity for the (meth)acrylic acid-base polymer. The polyhydric alcohols may be used individually or in combination of two or more thereof.

The polyhydric alcohol is added in an amount of 40 to 94.5%, preferably from 70 to 90%, based on the entire amount of the composition. If the amount added is less than 40%, the solubility of a medicament in the base becomes insufficient and the absorption into the skin decreases.

If the amount added exceeds 94.5%, the thickening effect by the polymer of (meth)acrylate is difficultly expressed and the adhesive layer can hardly have a satisfactory shape retentivity.

A solvent other than polyhydric alcohols can also be added, if desired, and examples of such a solvent include organic solvents miscible with water, such as monohydric alcohols (e.g., methanol, ethanol, propanol, benzyl alcohol, phenethyl alcohol, isopropyl alcohol, isobutyl alcohol, hexyl alcohol, 2-ethylhexanol, cyclohexanol, octyl alcohol, butanol, pentanol), ketones (e.g., acetone, methyl ethyl ketone), cellosolve, dioxane, dimethylformamide, N-methylpyrrolidone and dimethylsulfoxide; and organic solvents immiscible with water, such as ethyl acetate and crotamiton.

In the adhesive composition for dermal patch of the present invention, an aluminum compound (D) is added as a crosslinking agent for the purpose of maintaining the shape retentivity of gel or preventing the “glue residue”.

The aluminum compound (D) is added in an amount of 0.01 to 20%, preferably from 0.1 to 10%, based on the entire amount of the composition. If the amount added is less than 0.01%, the crosslinking insufficiently proceeds and the base becomes stringy, whereas if it exceeds 20%, the gel becomes excessively hard and the adherence of the composition deteriorates. The adherence can be freely controlled by changing the amount of the aluminum compound.

Examples of the aluminum compound include aluminum chloride, aluminum potassium sulfate, aluminum ammonium sulfate, aluminum nitrate, aluminum sulfate, EDTA-aluminum, aluminum hydroxide-sodium bicarbonate co-precipitate (for example, “Kumulite” produced by Kyowa Chemical Industry Co., Ltd.), synthetic aluminum silicate, aluminum stearate, aluminum allantoinate, synthetic hydrotalcite (for example, “Alcamac”, “Alcamizer” and “KYOWORD”, produced by Kyowa Chemical Industry Co., Ltd.), magnesium hydroxide-aluminum hydroxide co-precipitate (for example, “Sanalmin” produced by Kyowa Chemical Industry Co., Ltd.), aluminum hydroxide (for example, “Dried Aluminum Hydroxide Gel S-100” produced by Kyowa Chemical Industry Co., Ltd.), aluminum acetate, dihydroxyaluminum aminoacetate (for example, “Glycinal” produced by Kyowa Chemical Industry Co., Ltd.), kaolin, magnesium aluminometasilicate (for example, “Neusilin” produced by Fuji Chemical Industry Co., Ltd.) and magnesium aluminosilicate. The aluminum compound may be either water-soluble or sparingly soluble. These aluminum compounds may be used individually or in combination of two or more thereof. Among these aluminum compounds, when a water-soluble aluminum compound and alumina magnesium hydroxide are used in combination, the initial crosslinking proceeds with the former and the later crosslinking proceeds with the latter, whereby an adhesive layer having excellent shape retentivity can be obtained in a short time.

A crosslinking agent other than the aluminum compound can also be added and examples thereof include inorganic acid salts of calcium, tin, iron, magnesium, manganese, zinc, barium or the like (for example, calcium chloride, magnesium chloride, iron alum, ferric sulfate, magnesium sulfate, EDTA-calcium, EDTA-magnesium, stannous chloride, calcium carbonate, calcium phosphate, calcium hydrogenphosphate, magnesium carbonate, barium sulfate, magnesium silicate, magnesium stearate and magnesium citrate), hydroxides (for example, calcium hydroxide, barium hydroxide, magnesium hydroxide (e.g., “KISUMA” produced by Kyowa Chemical Industry Co., Ltd.), ferric hydroxide and stannous hydroxide), oxides (for example, magnesium oxide (e.g., “KYOWAMAG”, “MAGSALAT”, produced by Kyowa Chemical Industry Co., Ltd.)), formaldehyde, and epoxy compounds such as ethylene glycol diglycidyl ether, glycerin diglycidyl ether, polyethylene glycol diglycidyl ether, propylene glycol diglycidyl ether and polypropylene glycol diglycidyl ether. These crosslinking agents can be used individually or in combination of two or more thereof.

Furthermore, an agent for controlling the crosslinking reaction rate may also be used and examples thereof include organic acids, organic acid salts and organic bases having a chelating or coordination ability for a metal ion, such as tartaric acid, citric acid, lactic acid, glycolic acid, malic acid, salicylic acid, fumaric acid, methanesulfonic acid, maleic acid, acetic acid, EDTA-disodium, urea, triethylamine and ammonia, and also include inorganic acids such as hydrochloric acid, phosphoric acid, sulfuric acid, nitric acid and hydrobromic acid.

For the purpose of enhancing the polyhydric alcohol-holding property, a polymer having high affinity for polyhydric alcohol can be added to the adhesive composition for dermal patch of the present invention. Examples of the polymer include polyvinylpyrrolidone, carboxyvinyl polymer which is a crosslinked polyacrylic acid, vinylpyrrolidone-ethyl acrylate copolymer, N-vinylacetamide copolymers such as N-vinylacetamide-sodium acrylate copolymer, N-vinylacetamide homopolymer, polyvinylsulfonic acid, crosslinked N-vinylacetamide polymer, polyitaconic acid, hydroxypropylcellulose and hydoxypropylmethylcellulose. Among these, polymers which are crosslinked by a crosslinking agent added for crosslinking the polymer of (meth)acrylate are preferred. More specifically, carboxyvinyl polymer, N-vinylacetamide-sodium acrylate copolymer, polyvinylsulfonic acid and the like are preferred and in view of holding ability, carboxyvinyl polymer and N-vinylacetamide-sodium acrylate copolymer are most preferred. In the N-vinylacetamide-sodium acrylate copolymer, the mass ratio of N-vinylacetamide and sodium acrylate is preferably in a range from 99.9 to 60:0.1 to 40.

This polymer is added in an amount of 0.1 to 20%, preferably from 1 to 10%, based on the entire amount of the composition. If the amount added is less than 0.1%, a sufficiently high holding power for the polyhydric alcohol cannot be obtained, whereas if it exceeds 20%, the contact feeling with skin is worsened and poor absorption of a medicament results.

A large number of medicaments can be administered by using the gel form of the present invention. Examples thereof will be described below, however, the present invention is not limited thereto.

(a) Corticosteroids:

Hydrocortisone, prednisone, beclometasone propionate, flumethasone, triamcinolone, triamcinolone acetonide, fluocinolone, fluocinolone acetonide, fluocinolone acetonide acetate, clobetasol propionate, etc.;

(b) Antiphlogistic Anodyne:

Salicylic acid, glycol salicylate, methyl salicylate, 1-menthol, camphor, sulindac, sodium trimethine, naproxen, fenbufen, piroxicam, triamcinolone, hydrocortisone acetate, indomethacine, ketoprofen, acetaminophen, mefenamic acid, flufenamic acid, ibufenac, loxoprofen, thiaprofen, pranoprofen, fenpurofen, dichlofenac, sodium dichlofenac, alclofenac, lornoxicam, planoprofen, oxyphenbutazone, ibuprofen, felbinac, ketronac, bermoprofen, napmeton, naproxen, flurbipropfen, fluocinonide, clobetasol propionate, COX-2 inhibitor (e.g., nimeslid, meroxycam, etodolac, celecoxib, rofecoxib), etc.

(c) Antifungal:

Clotrimazole, tolnaftate, econazole nitrate, omoconazole nitrate, thioconazole nitrate, ketoconazole, nitrate, miconazole nitrate, isoconazole nitrate, tolnaftate, thioconazole nitrate, sulconazole nitrate, pyrrolnitrin, Pimafusin, undecylenic acid, salicylic acid, siccanin, nystatin, nornaftate, exalamide, phenyliodoundecynoate, thianthol, cyclopirox olamine, haloprogin, trichomycin, varition, pentamycin, amphotericin B, etc.

(d) Antihistamine:

Antibiotics such as tetracycline hydrochloride, diphenhydramine hydrochloride, chlorpheniramine, diphenylimidazole and chloramphenicol, diphenhydramine, chloropheniramine maleate, etc.

(e) Hyponic Sedative:

Phenobarbital, amobarbital, cyclobarbital, lorazepam, haloperidol, etc.

(f) Ataractic:

Fluphenazine, theoridazine, diazepam, flunitrazepam, chlorpromazine, etc.

(g) Antihypertensive:

Clonidine, clinidine hydrochloride, pindolol, propranol, propranol hydrochloride, Bupranolol, indenolol, bucumolol, nifedipine, etc.

(h) Depressing Diuretic:

Hydrothiazaide, bendrofluthiazide, cyclopenthiazide, etc.

(i) Antibiotic:

Penicillin, tetracycline, oxytetracycline, fradiomycin sulfate, erythromycin, chloramphenicol, etc.

(j) Anesthetic:

Lidocaine, benzocaine, ethylaminobenzoate, dibucaine, etc.

(k) Antibacterial Substance:

Benzalkonium chloride, nitrofurazone, nystatin, acetosulfamine, clotrimazole, etc.

(l) Vitamin Preparation:

Vitamin A, ergocalciferol, cholecalciferol, octotiamine, liboflavin butyrate, etc.

(m) Antiepileptic:

Nitrazepam, meprobamate, clonazepam, etc.

(n) Coronary Vasodilator:

Nitroglycerin, nitroglycol, isosorbide dinitrate, erythritol tetranitrate, pentaerythritol tetranitrate, propatyl nitrate, etc.

(o) Antihistamine

Diphenhydramine hydrochloride, chlorpheniramine, diphenylimidazole, etc.

(p) Antitussive:

Dextromethorphan, terbutamine, ephedrine, ephedrine hydrochloride, etc.

(q) Sexual Hormone:

Progesterone, estradiol, etc.

(r) Antidepressant:

Doxepin, etc.

(s) Angina Treating Agent:

Antiperspirants such as diethylamide and camphor, nitroglycerin, isosorbide nitrate, etc.

(t) Anesthetic Anodyne:

Morphine hydrochloride, ethylmorphine hydrochloride, morphine sulfate, cocaine hydrochloride, petidine hydrochloride, codeine phosphate, dihydrocodeine phosphate, fantails citrate, sufentanil and meperidine hydrochloride, etc.

(u) Crude Drug:

Phellodendron Bark, Pruni Jamasakura bark, Polygala Root, Zedoary, chamomile, Trichosanthis Semen, liquorice, Platycodon Grandiflorum, Armeniacae Semen, Bezoar Bovis, Schisandra Fruit, Gleditsia japonica, Bupleurum Root, Asiasarum Root, Plantago Seed, Cimicifuga Rhizome, Senega, Atractylodes Lancea Rhizome, Mulberry Bark, Clove, Citrus Unshiu Peel, Ipecac, Nandina Fruit, Fritillaria Bulb, Ophiopogon Tuber, Pinellia Tuber, Atractylodes Rhizome, Hyoscyamus niger., Saposhnikovia Root, Ephedra Herb, Capsicum extract, etc.

(v) Others:

5-fluorouracil, dihydroergotamine, fentanil, desmopressin, digoxin, metoclopramide, domperidone, scopolamine, scopolamine hydrobromide, medicament for animals, sleep-inducing drug, treating agent for circulatory system, agent for activating cerebral metabolism, microbicide, enzyme preparation, enzyme inhibitor, biopharmaceutical (polypeptide), agent for treating keratosis, narcotic, antitumor agent, general anesthetic, antianxiety agent, medication for asthma and nasal allergy, antiparkinsonism, agent used in chemotherapy treatment, vermicide, antiprotozoiasis, styptic, cardiac, stimulant•antihypnotic, medication for treating habitual toxipathy, Chinese herbal medicine, radiophamaceutical, medication for urogenital system and anus, blood sugar lowering agent, antiulcer, medication for head hair, sequestering agent, antisweating agent, tranquilizer, blood anticoagulant, antirheumatic, antigout, anticoagulant, etc.

These medicaments can be used in combination of two or more, if desired. The ratio of the medicament blended is preferably from 0.01 to 30 mass %, more preferably from 2 to 20 mass %, to the total mass of the adhesive composition for dermal patch.

Among the above drugs, capsaicin contained, for example, in Capsicum extract is known to give strong irritation to skin when a large amount of water is present together. The adhesive composition for dermal patch of the present invention is small in the water content and therefore, a capsaicin-containing hot-type dermal patch less irritating to skin can be produced.

Moreover, it has been recently reported that VR1 receptors, i.e. the receptors for capsaicin which is responsible for hot-flavor of capsicum, are activated by heat of 43° C. or higher or by elevation of acidity, instead of capsaicin, to transmit signals of the thermal stimuli or pain stimuli to the brain (“Journal of Clinical and Experimental Medicine(Igaku no Ayumi)”, Vol. 201 No. 13, 1071-1075, 2002). Based on this finding, studies for utilizing capsaicin in analgesic preparation have been being made. That is, by using the adhesive composition of the present invention, anti-irritant, transdermal pain-relieving patches containing capsaicin can be produced. Such a patch can be, in particular, suitably used for treating post-zoster neuralgia. As a symptom of post-zoster neuralgia, the pain occurs along the nerve, and is present in the body area of a belt-like-shape. Therefore, transdermal pain-relieving patches for treating the pain have the following forms. For example, the patch is produced in a form of a roll having a width of 1 to 10 cm. The patch roll is cut in a length suitable for the pain area upon use. Examples of small-sized patch products include round-shaped patches having a diameter of 1 to 10 cm, square-shaped patches of 1 to 10 cm on a side, and rectangle-shaped ones which can be applied to the pain area in rows.

In preparation of the adhesive composition for dermal patch of the present invention, medical agents can be incorporated at the solution stage (or the gel suspension stage) or after the aging for crosslinking reaction. A suitable method varies according to the properties of the medical agent, the administration site and the objective release rate.

An auxiliary agent for accelerating the absorption of the medicinal ingredients can also be added. Examples of auxiliary agent include ethyl alcohol, isopropyl alcohol, n-butanol, 1,3-butanediol, propylene glycol, polyethylene glycol #400, glycerin, crotamiton, benzyl alcohol, phenyl ethyl alcohol, propylene carbonate, hexyl dodecanol, propanol, salicylic acid, allantoin, dimethylsulfoxide, dimethylacetamide, dimethylformamide, diisopropyl adipate, diethyl sebacate, ethyl laurate, lanolin, azone, 1-geranylazacycloheptan-2-one (GACH), fatty acid dialkylolamide, keratin softening agents such as salicylic acid, salicylic acid derivative, urea and sulfur; humectants such as pyrrolidone carboxylic acid; surfactants such as propylene glycol monooleate, polyoxyethylene sorbitan monostearate, sorbitan monostearate and glycerin monostearate; esters such as isopropyl myristate and diethyl sebacate; higher alcohol such as oleyl alcohol, stearyl alcohol and lauryl alcohol; fatty acids such as stearic acid, hexanoic acid, nonanoic acid, decanoic acid, dodecanoic acid, tetradecanoic acid, hexadecanoic acid, octadecanoic acid, oleic acid and linoleic acid; terpene-base compounds and surfactants, such as menthol, menthone, limonene, pinene, piperitone, terpinene, terpinolene, terpinol and carveol; and adjuvants such as allantoin, dimethylsulfoxide, dimethylacetamide, dimethylformamide, diisopropyl adipate, diethyl sebacate, ethyl laurate, lanolin and azone. Other examples of the auxiliary agent which is added if desired, include coolant agents such as menthol, warming agents such as camphor, oil ingredients such as almond oil, olive oil, camellia oil, persic oil, peppermint oil, sesame oil, soybean oil, mink oil, cottonseed oil, corn oil, safflower oil, coconut oil, eucalyptus oil, castor oil, liquid paraffin, petrolatum, squalene, squalane and lanolin, gelling agents such as carboxyvinyl polymer and neutralizers such as diisopropanolamine. One or more of these auxiliary agents can be blended. In view of skin irritation or the like, the auxiliary agent is preferably blended in an amount of 0.1 to 5 parts by mass per 100 parts by mass of the medicament.

In the composition used in the present invention, for the purpose of more successfully bringing out the characteristics of the composition, improving the processing and shaping property and the quality, or improving the dispersibility and stability of the medicament in the gel, an additive selected according to the purpose can be further arbitrarily blended to an extent of not impairing the performance of the gel. Examples of the additive are as follows. (1) Moisturizer:

Glycerin, propylene glycol, sorbitol, 1,3-butylene glycol, dl-pyrrolidonecarboxylic acid, sodium lactate, etc.

(2) Astringent:

Citric acid, tartaric acid, lactic acid, aluminum chloride, aluminum sulfate, allantoin chlorohydroxyaluminum, allantoin dihydroxyaluminum, aluminum phenolsulfate, zinc paraphenolsulfonate, zinc sulfate, aluminum chlorohydroxide, etc.

(3) Moisture-Holding Agent:

Polyhydric alcohols such as glycerin, propylene glycol, 1,3-butylene glycol, sorbitol, polyglycerin, polyethylene glycol and dipropylene glycol; NMF ingredients such as sodium lactate, water-soluble polymers such as hyaluronic acid, collagen, mucopolysaccharide and chondroitin sulfate, etc.;

(4) Thickener:

Natural polymers such as acacia, traganth gum, locust bean gum, guar gum, echo gum, karaya gum, agar, starch, carrageenan, alginic acid, alginates (e.g., sodium alginate), propylene glycol alginate, dextran, dextrin, amylose, gelatin, collagen, pullulan, pectin, amylopectin, sodium amylopectin semiglycolate, chitin, albumin and casein, semi-synthetic polymers such as polyglutamic acid, polyaspartic acid, methylcellulose, ethylcellulose, propylcellulose, ethylmethylcellulose, hydroxyethylcellulose, hydroxypropylcellulose, hydroxypropylmethylcellulose, carboxymethyl starch, alkali metal carboxymethylcellulose, alkali metal cellulose sulfate, cellulose graft polymer, crosslinked gelatin, cellulose acetate phthalate, starch-acrylic acid graft copolymer, phthalic anhydride-modified gelatin and succinic acid-modified gelatin, and synthetic polymers such as polyvinyl alcohol, polyvinylpyrrolidone, polyvinyl methyl ether, carboxyvinyl polymer, vinylpyrrolidone-ethyl acrylate copolymer, vinylpyrrolidone-styrene copolymer, vinylpyrrolidone-vinyl acetate copolymer, vinyl acetate-(meth)acrylic acid copolymer, polyvinyl acetate-crotonic acid copolymer, N-vinylacetamide base copolymers (e.g., N-vinylacetamide-sodium acrylate copolymer), polyvinyl sulfonic acid, crosslinked N-vinylacetamide polymer, polyitaconic acid, polyhydroxyethyl acrylate, polyacrylamide, styrene-maleic anhydride copolymer and acrylamide-acrylic acid copolymer, etc.

(5) Substance for Imparting Adhesiveness:

Silicone rubber, polyisoprene rubber, styrene block copolymer rubber, acrylic rubber, natural rubber, etc.

(6) Anti-Itching Agent:

Camphor, thymol, menthol, polyoxyethylene lauryl ether, antihistamine, ethyl aminobenzoate, etc.

(7) Keratin Softening and Peeling Agent:

Sulfur, thioxolone, selenium sulfide, salicylic acid, resorcin, etc.

(8) Substance for Preventing Accidental Ingestion:

Powdered capsicum, capsicum extract, etc.

(9) Powder Raw Material:

Montmorillonite, silicic anhydride, gypsum, carbon black, diatomaceous earth, red oxide of iron, calcium carbonate, hydrotalcite, talc, glass, kaolin, bentonite, metal soap, aerosil, titanated mica, bismuth oxychloride, fish scale flake, zinc white, titanium dioxide, etc.

(10) Oily Raw Material:

Almond oil, olive oil, hardened oil, camellia oil, castor oil, Japan wax oil, coconut oil, beeswax, spermaceti, lanolin, carnauba wax, candelilla wax, liquid paraffin, petrolatum, microcrystalline wax, ceresin, squalene, lauric acid, myristic acid, palmitic acid, stearic acid, isostearic acid, oleic acid, lauryl alcohol, cetanol, stearyl alcohol, oleyl alcohol, octyldodecanol, cholesterol, hexyldecanol, white sterol, cetyl lactate, isopropyl myristate, hexyl laurate, myristyl myristate, isopropyl palmitate, octyldodecanol myristate, butyl stearate, cacao oil, jojoba oil, grape seed oil, avocado oil, mink oil, egg yolk oil, ceresin wax, paraffin wax, behenic acid, isopropyl adipate, octyldodecyl myristate, octyldodecyl oleate, cholesterol oleate, etc.

(11) Surfactant:

Anionic surfactants such as lauryl sulfate, polyoxyethylene alkyl ether sulfate, alkylbenzene sulfonate, polyoxyethylene alkyl ether phosphoric acid, polyoxyethylene alkyl phenyl ether phosphoric acid, N-acylamino acid salt, sodium stearate, potassium palmitate, sodium cetylsulfate, sodium laurylsulfate, triethanolamine palmitate, sodium polyoxyethylenelaurylphosphate, sodium acylglutamate and surfactin, cationic surfactants such as benzalkonium chloride, benzetonium chloride, stearyltrimethylammonium chloride, distearyldimethylammonium chloride and stearyldimethylbenzylammonium chloride, amphoteric surfactants such as alkyldiaminoethylglycine hydrochloride, 2-alkyl-N-carboxymethyl-N-hydroxyethyl-imidazolinium betaine, lauryl dimethylaminoacetic acid betaine and lecithin, nonionic surfactants such as polyol fatty acid ester, glycerol monostearate, lipophilic glycerol monooleate, ethylene glycol monostearate, propylene glycol monostearate, sorbitan fatty acid ester, polyoxyethylene sorbitan fatty acid ester, polyoxyethylene fatty acid ester, polyoxyethylene alkyl ether, polyoxyethylene alkyl phenol ether, polyoxyethylene sorbitol fatty acid ester, N-acylamino acid ester, sucrose fatty acid ester, fatty acid alkylolamide, polyoxyethylenated sterol, polyoxyethylenated lanolin and polyoxyethylene hydrogenated castor oil, etc.

(12) Coloring Agent:

Yellow oxide of iron, red oxide of iron, black oxide of iron, ultramarine, carbon black, chromium hydroxide, chromium oxide, tar pigment, lake, Food Red 2, Food Red 3, Food Red 102, Food Red 201, Food Yellow 4, Food Yellow 5, Food Blue 1, Food Blue 2, etc.

(13) Perfume:

Plant perfumes such as mustard oil, orange oil, pepper oil, jasmine oil, Japan cedar oil, iris oil, terpine oil, orange flower oil, rose oil, eucalyptus oil, lime oil, lemon oil, Japanese mint oil and rosemary oil, animal perfumes such as musk, civet, castoreum and ambergris, hydrocarbon-base perfumes such as bromostyrol, pinene and limonene, alcohol-base perfumes such as benzyl alcohol and 1-menthol, ester-base perfumes such as ethyl acetate and methyl salicylate, aldehyde-base perfumes such as benzaldehyde and salicylaldehyde, ketone-base perfumes such as camphor, muscone, musk ketone and 1-menthone, ether-base perfumes such as safrol, phenol-base perfumes such as thymol, lactone-base perfumes, acid-base perfumes such as phenylacetic acid, nitrogen compound-base perfumes such as indole, etc.

(14) Ultraviolet Light Shielding Agent:

Benzophenone type such as ASL-24, Cyasorb UV-9 and Uvinul M-40, benzoic acid type such as Salol, azole type such as Tinuvin P, nitrile type such as Uvinul N-35, urea type such as Ancour UA, p-amino acid type such as Neo Heliopan Give tan F, 2-hydroxy-4-methoxybenzophenone, octyldimethyl p-aminobenzoate and ethylhexyl p-methoxycinnamate, salicylic acid type, benzofuran type, coumarin type, azole type, etc.

(15) Antiseptic and Microbicide:

Acids such as benzoic acid, salicylic acid, dehydroacetic acid, sorbic acid and boric acid, salts of these acids, phenols such as phenol, chlorocresol, chloroxylenol, isopropylmethylphenol, resorcin, o-phenylphenol, p-oxybenzoic acid ester, phenoxyethanol, thymol, hinokitiol and thioxolone, halogenated bisphenols such as hexachlorophene and 2,4,4′-trichloro-2′-hydroxydiphenyl ether, amide compounds such as trichlorocarbanilide, halocarban and undecylenic acid monoethanolamide; quaternary ammonium compounds such as benzalkonium chloride, alkylisoquinolinium bromide, benzethonium chloride and cetylpyridinium chloride; amphoteric surfactants such as lauryl di(aminoethyl)glycine; 2-pyridinethiol-1-oxide zinc salt, gluconic acid, chlorhexidine, thiram, N-trichloromethylthio-4-cyclohexene-1,2-dicarboximide, chlorobutanol, etc.

(16) Antioxidant:

Nordihydroguaiaretic acid, guaiacum, propyl gallate, butylhydroxyanisole, dibutylhydroxytoluene (BHT), tocopherol (vitamin E), 2,2′-methylenebis(4-methyl-6-tert-butyl)phenol, etc.

(17) Chelating Agent:

Edetate, pyrophosphate, hexameta-phosphate, citric acid, tartaric acid, gluconic acid, etc.

(18) Ultraviolet Scattering Agent:

Titanium oxide, kaolin, talc, etc.

(19) pH Adjusting Agent:

Alkalis such as alkali metal hydroxides, alkaline earth metal hydroxides, primary, secondary or tertiary alkylamines, and primary, secondary or tertiary alkanolamines, e.g., sodium hydroxide, potassium hydroxide, calcium hydroxide, magnesium hydroxide, ammonia, aqueous ammonia, triethanolamine, dimethylamine, diethylamine, trimethylamine, triethylamine, triisopropanolamine, trisodium phosphate, disodium hydrogenphosphate, dipotassium hydrogenphosphate, monoethanolamine, diethanolamine, diisopropanolamine and polyethanolamine, acids such as citric acid, tartaric acid, lactic acid, glycolic acid, hydrochloric acid, nitric acid, malic acid, phosphoric acid, polymers exhibiting acidity or alkalinity, such as alginic acid, polyglutamic acid, polyaspartic acid, starch-acrylic acid graft polymer, polyacrylic acid, polyvinyl acetate-crotonic acid copolymer, vinyl acetate-(meth)acrylic acid copolymer, vinyl acetate-(meth)acrylic acid copolymer, vinyl acetate-crotonic acid copolymer, polyvinylsulfonic acid, polyitaconic acid, styrene-maleic anhydride copolymer and acrylamide-acrylic acid copolymer, etc.

In addition, a stabilizer, a filler, a preservative, a plasticizer, a softening agent, a deterioration inhibitor and the like may be added and these additives can be freely added within the range of not adversely affecting the properties of the obtained adhesive composition for dermal patch.

In the present invention, the adhesive composition for dermal patch is prepared by directly mixing respective raw materials, casting the resulting sol into an appropriate mold and crosslinking the sol there or further shaping the gel after crosslinking into various articles by means of an appropriate molding machine, tablet machine or the like. The raw materials can be mixed by appropriately selecting and using, for example, a kneader, a co-kneader, Kneader-Ruder, Agi-Homomixer, a planetary mixer or a double planetary mixer.

At the mixing, (A) the (meth)acrylic acid-base polymer and a solution of (C) the polyhydric alcohol in (B) water are mixed to have a water concentration of 50% or more based on the total mass thereof and the remaining components ((C) residual polyhydric alcohol, (D) the aluminum compound and if desired, (E) the polymer compound) are added and mixed to adjust the water concentration to 5 to 30%, whereby the (meth)acrylic acid-base polymer can be readily dissolved and the adhesive composition for dermal patch of the present invention can be produced within a shorter time.

For example, 5 g of sodium polyacrylic acid is thoroughly dispersed in 45 g of glycerin and the resulting dispersion is added to 50 g of water while kneading. At this time, the water concentration is 50% and therefore, the polymer dissolves within a short time to readily provide a uniform system. After confirming that the polymer is uniformly dissolved, the system is kneaded while adding the remaining 100 g of glycerin and thereby, the water concentration in the final composition can be adjusted to 25%. This method is characterized in that if the polymer is once dissolved, even when the polyhydric alcohol is added later, the polymer is not precipitated but remains being dissolved.

The adhesive composition for dermal patch can be sheeted by coating an appropriate amount of the adhesive on one surface or both surfaces of a support such as paper, wood, metal, glass fiber, cloth (e.g., flannel, woven fabric, nonwoven fabric), synthetic resin (e.g., polyurethane, ethylene-vinyl acetate copolymer, polyvinyl chloride, polyester (e.g., polyethylene terephthalate), polyolefin (e.g., polyethylene, polypropylene), polyamide (e.g., nylon 6, nylon 66), polyvinylidene chloride, polytetrafluoroethylene), metal foil (e.g., aluminum), rubber, cellulose derivative or a molded article thereof (for example, a laminate film with plastic film), a sheet (foil) or a tape. For facilitating the storage of the obtained sheet-form adhesive composition for dermal patch, it is preferred that a release sheet treated with silicone or by other appropriate methods is affixed onto the surface coated with the adhesive for dermal patch. Examples of the release sheet which can be used include polyethylene film, polypropylene film, release paper, cellophane, polyvinyl chloride and polyester.

Alternatively, the surface which is not coated with the adhesive for dermal patch is treated with silicone or by other appropriate methods to form a release surface, and the sheet is rolled with the coated surface inside, or plural sheets may be laminated with an adhesive-coated surface being on an non-adhesive surface.

### BEST MODE FOR CARRYING OUT THE INVENTION

The usefulness of the present invention is described below by referring to Examples, however, the present invention is not limited thereto. In Examples, the “parts” is “parts by mass”.

### EXAMPLE 1

Blended components and blending ratio

| | | |
|---|---|---|
| Sodium polyacrylate | 2 | parts |
| (viscosity* 560 mPa · s) | | |
| Glycerin | 75.9 | parts |
| Aluminum sulfate | 1 | part |
| magnesium hydroxide-aluminum hydroxide | 0.5 | parts |
| co-precipitate | | |
| Water | 18.975 | parts |
| Sodium hydroxide | 0.625 | parts |
| Carboxyvinyl polymer | 1 | part |

*The viscosity in 0.2 mass % aqueous solution in all the Examples was measured using B-type viscosity meter (measuring condition: 20° C., Rotor No. 2, 30 rpm, 30 minutes)

Formulation

A dispersion of sodium polyacrylate (“Viscomate F480SS” produced by Showa Denko K.K.) (2 parts) and glycerin (10 parts) was added and mixed to a mixed solution of water (12.5 parts) and aluminum sulfate (1 part). When the polymer was started to dissolve and the solution was thickened, a mixed solution of glycerin (65.9 parts), carboxyvinyl polymer (“AQUPEC HV-504E” produced by Sumitomo Seika Chemicals Co., Ltd.) (1 part) and magnesium hydroxide-aluminum hydroxide co-precipitate (“Sanalmin” produced by Kyowa Chemical Industry Co., Ltd.) (0.5 parts) was added and finally, a solution of sodium hydroxide (0.625 parts) and water (6.475 parts) was gradually added and kneaded until the system became uniform.

The obtained sol was shaped, sealed, aged at about 20° C. for 3 days and then taken out from the container. When the resulting gel was touched with a finger, elongation and strong resilience were exhibited.

### EXAMPLE 2

Blended components and blending ratio

| | | |
|---|---|---|
| Acrylic acid/sodium acrylate | 5.5 | parts |
| (10/90 (by mol)) copolymer | | |
| (viscosity 401 mPa · s) | | |
| Glycerin | 75.86 | parts |
| Capsaicin | 0.5 | parts |
| Aluminum sulfate | 1.6 | parts |
| Purified water | 14.54 | parts |
| N-vinylacetamide/sodium acrylate | 2 | parts |
| (90/10 (by mass)) copolymer | | |

Formulation

A mixed solution of acrylic acid/sodium acrylate copolymer (5.5 parts), glycerin (12.94 parts), capsaicin (0.5 Parts) and N-vinylacetamide/sodium acrylate copolymer (2 parts) was gradually added to a mixed solution of aluminum sulfate (1. 6 parts) and purified water (14.54 parts). When the solution became uniform, glycerin (62.92 parts) was gradually added and kneaded until the system became uniform.

The obtained sol was shaped, sealed, aged at about 20° C. for 3 days and then taken out from the container. When the resulting gel was touched with a finger, elongation and strong resilience were exhibited.

### EXAMPLE 3

Blended components and blending ratio

| | | |
|---|---|---|
| Sodium polyacrylate | 4 | parts |
| (viscosity 675 mPa · s) | | |
| Glycerin | 57.9 | parts |
| Propylene glycol | 15 | parts |
| Aluminum sulfate | 1 | part |
| Purified water | 18.6 | parts |
| Carboxyvinyl polymer | 2 | parts |
| Diclofenac sodium | 1 | part |
| magnesium hydroxide-aluminum hydroxide | 0.5 | parts |
| co-precipitate | | |

Formulation

Sodium polyacrylate (4 parts) and glycerin (13.6 parts) were added to a mixed solution of aluminum sulfate (1 part) and purified water (18.6 parts) and kneaded until the system became uniform. Subsequently, a mixed solution of glycerin (44.3 parts), propylene glycol (15 parts), carboxyvinyl polymer (“CARBOPOL 934” produced by Noveon Inc.) (2 parts) and magnesium hydroxide-aluminum hydroxide co-precipitate (“Sanalmin” produced by Kyowa Chemical Industry Co., Ltd.) (0.5 parts) was gradually added and diclofenac sodium (1 part) was further added and kneaded.

The obtained sol was shaped, sealed, aged at about 20° C. for 3 days and then taken out from the container. When the resulting gel was touched with a finger, elongation and strong resilience were exhibited.

On the other hand, the obtained sol was coated on a polyvinyl chloride-made support by a knife coater with a clearance of 0.5 mm and after aging at 20° C. for 3 days, the percutaneous absorbability was measured.

### EXAMPLE 4

Blended components and blending ratio

| | | |
|---|---|---|
| Potassium polyacrylate | 4 | parts |
| (viscosity 525 mPa · s) | | |
| Acrylic acid/sodium acrylate | 0.5 | parts |
| (65/35 (by mol)) copolymer | | |
| Tartaric acid | 1 | part |
| Synthetic hydrotalcite | 1 | part |
| Aluminum potassium sulfate | 1 | part |
| Aluminum oxide | 18 | parts |
| Glycerin | 61.5 | parts |
| Crosslinked N-vinylacetamide polymer | 2 | parts |
| Purified water | 5 | parts |
| Crotamiton | 5 | parts |
| Indomethacine | 1 | part |

Formulation

A mixture of potassium polyacrylate (4 parts) and acrylic acid/sodium acrylate copolymer (0.5 parts) was added at once to a mixed solution of purified water (5 parts) and glycerin (0.5 parts) and thoroughly kneaded. Subsequently, a mixed solution of tartaric acid (1 part), synthetic hydrotalcite (“Alcamac” produced by Kyowa Chemical Industry Co., Ltd.) (1 part), aluminum potassium sulfate (1 part), aluminum oxide (18 parts), crosslinked N-vinylacetamide polymer (2 parts) and glycerin (61 parts) was gradually added and again kneaded. After confirming the system became uniform, a solution of crotamiton (5 parts) and indomethacine (1 part) was gradually added and kneaded until the system became uniform.

The obtained sol was shaped, sealed, aged at about 20° C. for 3 days and then taken out from the container. When the resulting gel was touched with a finger, elongation and strong resilience were exhibited.

### EXAMPLE 5

Blended components and blending ratio

| | | |
|---|---|---|
| Sodium acrylate/potassium methacrylate | 30 | parts |
| (50/50 (by mol)) copolymer | | |
| (viscosity 513 mPa · s) | | |
| Lactic acid | 0.01 | part |
| Aluminum hydroxide | 0.01 | part |
| Sorbitol polyglycidyl ether | 0.1 | part |
| Glycerin | 19.88 | parts |
| 1,3-Butanediol | 10 | parts |
| Propylene glycol | 10 | parts |
| Purified water | 30 | parts |

Formulation

A mixed solution of sodium acrylate/potassium methacrylate copolymer (30 parts) and glycerin (19.88 parts) was added at once to purified water (30 parts) and thoroughly kneaded until the system became uniform. Subsequently, a mixed solution of lactic acid (0.01 part), sorbitol polyglycidyl ether (“DENACOL EX-614B” produced by Nagase Kasei Kogyo K.K.) (0.1 part), dried aluminum hydroxide gel (produced by Kyowa Chemical Industry Co., Ltd.) (0.01 part), 1,3-butanediol (10 parts) and propylene glycol (10 parts) was gradually added and at the same time, kneaded.

The obtained sol was shaped, sealed, aged at about 20° C. for 3 days and then taken out from the container. When the resulting gel was touched with a finger, elongation and strong resilience were exhibited.

### EXAMPLE 6

Blended components and blending ratio

| | | |
|---|---|---|
| Sodium polyacrylate | 2 | parts |
| (viscosity 560 mPa · s) | | |
| Glycerin | 75.5 | parts |
| Aluminum sulfate | 0.5 | parts |
| Magnesium hydroxide-aluminum hydroxide | 0.15 | parts |
| co-precipitate | | |
| Aluminum hydroxide dry gel | 0.20 | parts |
| Water | 20.025 | parts |
| Sodium hydroxide | 0.625 | parts |
| Carboxyvinyl polymer | 1 | parts |

Formulation

A dispersion of sodium polyacrylate (“Viscomate F480SS” produced by Showa Denko K.K.) (2 parts) and glycerin (10 parts) was added and mixed to a mixed solution of water (12.025 parts) and aluminum sulfate (0.5 parts). When the polymer was dissolved and the mixed solution was thickened, a mixed solution of glycerine (65.5 parts) and carboxyvinyl polymer (“AQUPEC HV-504E” produced by Sumitomo Seika Chemicals Co., Ltd.) (1 part), aluminum hydroxide dry gel (a low water content type, produced by Kyowa Chemical Industry Co., Ltd.) (0.20 parts) and magnesium hydroxide-aluminum hydroxide co-precipitate (“Sanalmin” produced by Kyowa Chemical Industry Co., Ltd.) (0.15 part) was added, and then after a solution of sodium hydroxide (0.625 parts) and water (8.00 parts) was added thereto, the solution was kneaded to be uniform.

The obtained sol was shaped, sealed, aged at about 20° C. for 3 days and then taken out from the container. When the resulting gel was touched with a finger, elongation and strong resilience were exhibited.

### EXAMPLE 7

Blended components and blending ratio

| | | |
|---|---|---|
| Sodium polyacrylate | 2 | parts |
| (viscosity 560 mPa · s) | | |
| Glycerin | 68.6 | parts |
| Isopropyl myristate | 7 | parts |
| Aluminum sulfate | 0.25 | parts |
| Magnesium hydroxide-aluminum hydroxide | 0.25 | parts |
| coprecipitate | | |
| Water | 20.153 | parts |
| Sodium hydroxide | 0.547 | parts |
| Polyoxyethylene sorbitan monooleate | 0.20 | parts |
| Carboxyvinyl polymer | 1 | part |

Formulation

A dispersion of sodium polyacrylate (“Viscomate F480SS” produced by Showa Denko K.K.) (2 parts) and glycerin (10 parts) was added and mixed to a mixed solution of water (12.153 parts), polyoxyethylene sorbitan monooleate (“Tween80” produced by Wako Pure Chemicals Industries, Ltd.) (0.20 parts) and aluminum sulfate (0.25 parts). When the polymer was dissolved and the mixed solution was thickened, a mixed solution of glycerin (58.6 parts), isopropyl myristate (7 parts) and carboxyvinyl polymer (“AQUPEC HV-504E” produced by Sumitomo Seika Chemicals Co., Ltd.) (1 part) and magnesium hydroxide-aluminum hydroxide co-precipitate (“Sanalmin” produced by Kyowa Chemical Industry Co., Ltd.) (0.25 parts) was added, and then after a solution of sodium hydroxide (0.547 parts) and water (8.00 parts) was gradually added thereto, the solution was kneaded to be uniform.

The obtained sol was shaped, sealed, aged at about 50° C. for 1 day and then taken out from the container. When the resulting gel was touched with a finger, elongation and strong resilience were exhibited.

### COMPARATIVE EXAMPLE 1

Blended components and blending ratio

| | | |
|---|---|---|
| Acrylic acid/sodium acrylate | 4 | parts |
| (30/70 (by mol)) copolymer | | |
| (viscosity 531 mPa · s) | | |
| Glycerin | 74 | parts |
| Aluminum sulfate | 1 | part |
| magnesium hydroxide-aluminum hydroxide | 1 | part |
| co-precipitate | | |
| Water | 16.75 | parts |
| Sodium hydroxide | 1.25 | parts |
| Carboxyvinyl polymer | 2 | parts |

Formulation

A dispersion of acrylic acid/sodium acrylate copolymer (“Viscomate NP-600” produced by Showa Denko K.K.) (4 parts) and glycerin (10 parts) was added and mixed to a mixed solution of water (10 parts) and aluminum sulfate (1 part). When the polymer started dissolving and the solution was thickened, a mixed solution of glycerin (64 parts), carboxyvinyl polymer (“AQUPEC HV-504E” produced by Sumitomo Seika Chemicals Co., Ltd.) (2 parts) and magnesium hydroxide-aluminum hydroxide co-precipitate (“Sanalmin” produced by Kyowa Chemical Industry Co., Ltd.) (1 part) was added and finally, a solution of sodium hydroxide (1.25 parts) and water (6.75 parts) was gradually added and kneaded until the system became uniform.

The obtained sol was shaped, sealed, aged at about 20° C. for 3 days and then taken out from the container. When the resulting gel was touched with a finger, resilience was not exhibited at all, glycerin exuded and the sol stuck to the finger.

### COMPARATIVE EXAMPLE 2

Blended components and blending ratio

| | | |
|---|---|---|
| Polyacrylic acid | 4 | parts |
| Glycerin | 74 | parts |
| Aluminum sulfate | 1 | part |
| magnesium hydroxide-aluminum hydroxide | 1 | part |
| co-precipitate | | |
| Water | 16.75 | parts |
| Sodium hydroxide | 1.25 | parts |
| Carboxyvinyl polymer | 2 | parts |

Formulation

A dispersion of polyacrylic acid (Mw: 4,000,000, produced by Sigma-Aldrich Co. ) (4 parts) and glycerin (10 parts) was added and mixed to a mixed solution of water (10 parts) and aluminum sulfate (1 part). When the polymer started dissolving and the solution was thickened, a mixed solution of glycerin (64 parts), carboxyvinyl polymer (“AQUPEC HV-504E” produced by Sumitomo Seika Chemicals Co., Ltd.) (2 parts) and magnesium hydroxide-aluminum hydroxide co-precipitate (“Sanalmin” produced by Kyowa Chemical Industry Co., Ltd.) (1 part) was added and finally, a solution of sodium hydroxide (1.25 parts) and water (6.75 parts) was gradually added and kneaded until the system became uniform.

The obtained sol was shaped, sealed, aged at about 20° C. for 3 days and then taken out from the container. When the resulting gel was touched with a finger, resilience was not exhibited at all and the sol stuck to the finger.

### COMPARATIVE EXAMPLE 3

Blended Components and blending ratio

| | | |
|---|---|---|
| Sodium polyacrylate | 4 | parts |
| (viscosity 560 mPa · s) | | |
| Glycerin | 30 | parts |
| Aluminum sulfate | 1 | part |
| Purified water | 61.5 | parts |
| Carboxyvinyl polymer | 2 | parts |
| Diclofenac sodium | 1 | part |
| magnesium hydroxide-aluminum hydroxide | 0.5 | parts |
| co-precipitate | | |

Formulation

Sodium polyacrylate (4 parts) and glycerin (13.6 parts) were added to a mixed solution of aluminum sulfate (1 part) and purified water (61.5 parts) and kneaded until the system became uniform. Subsequently, a mixed solution of glycerin (16.4 parts), carboxyvinyl polymer (“CARBOPOL 934” produced by Noveon Inc.) (2 parts) and magnesium hydroxide-aluminum hydroxide co-precipitate (“Sanalmin” produced by Kyowa Chemical Industry Co., Ltd.) (0.5 parts) was gradually added and diclofenac sodium (1 part) was further added and kneaded.

The obtained sol was shaped, sealed, aged at about 20° C. for 3 days and then taken out from the container. When the resulting gel was touched with a finger, strong resilience was exhibited.

On the other hand, the obtained sol was coated on a polyvinyl chloride-made support by a knife coater with a clearance of 0.5 mm and after aging at 20° C. for 3 days, the percutaneous absorbability was measured.

### TEST EXAMPLE

### Percutaneous Absorbability of a Transdermal Patch using Diclofenac Sodium

The back of Wister rat of 180 to 220 g was unhaired and transdermal patch using the gel of Example 3 or Comparative Example 3 was affixed to give a dosage of 50 mg/kg. The concentration in blood was measured by HPLC with the passage of time and the change of concentration in blood plasma was observed. The results obtained are shown in Table 1.

TABLE 1
Percutaneous Absorbability of Diclofenac Sodium Transdermal Patch

Time (h)

| | 2 | 4 | 6 | 8 |
|---|---|---|---|---|
| Example 3: | 0.28 | 0.44 | 0.63 | 0.85 |
| concentration (μg/ml-plasma) | | | | |
| Comparative Example 3: | 0.06 | 0.08 | 0.11 | 0.14 |
| concentration (μg/ml-plasma) | | | | |

### INDUSTRIAL APPLICABILITY

The adhesive composition for dermal patch of the present invention is obtained by dispersing or dissolving a (meth)acrylate polymer and a percutaneous absorbing medicament in an aqueous high-concentration polyhydric alcohol solution, so that a large amount of polyhydric alcohol can be contained between skeletons of the adhesive layer and a stable base material free from syneresis of the polyhydric alcohol can be formed. Furthermore, agent for the dermal patches using the adhesive composition of the present invention exhibits excellent release property, good adherence and high safety.

1. An adhesive composition for dermal patch, comprising
(A) a (meth)acrylic acid-base polymer having repeating units represented by formulae (1) and (2): 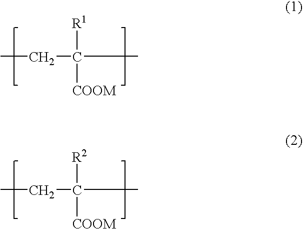
wherein R¹ and R² each independently represents a hydrogen atom or a methyl group and M represents NH₄⁺ or an alkali metal,
with a ratio of (1)/(2) being in a range from 100/0 to 90/10 (by mol),
(B) water,
(C) a polyhydric alcohol and
(D) an aluminum compound,
with the content of (B) water being from 5 to 30 mass %.

2. The adhesive composition for dermal patch as claimed in claim 1, wherein (A) the (meth)acrylic acid-base polymer having repeating units represented by formulae (1) and (2) has a viscosity of 400 mPa·s or more in 0.2 mass % aqueous solution: 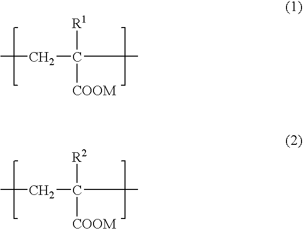
wherein all the symbols have the same meaning as defined in claim 1.

3. The adhesive composition for dermal patch as claimed in claim 1, wherein the polyhydric alcohol is a trivalent or of a higher valence.

4. The adhesive composition for dermal patch as claimed in claim 3, wherein the polyhydric alcohol is glycerin.

5. The adhesive composition for dermal patch as claimed in claim 1, wherein the polyhydric alcohol content is from 40 to 94.5 mass % based on the entire amount of the composition.

6. The adhesive composition for dermal patch as claimed in claim 1, wherein a water-soluble aluminum compound and a magnesium hydroxide aluminum hydroxide co-precipitate are used in combination as the aluminum compound.

7. The adhesive composition for dermal patch as claimed in claim 1, wherein the aluminum compound content is from 0.01 to 20 mass % based on the entire amount of the composition.

8. The adhesive composition for dermal patch as claimed in claim 1, which further comprises (E) a polymer compound having high affinity for the polyhydric alcohol.

9. The adhesive composition for dermal patch as claimed in claim 8, wherein (E) the polymer compound having high affinity for the polyhydric alcohol is at least one member selected from the group consisting of a carboxyvinyl polymer and an N-vinylacetamide-sodium acrylate copolymer.

10. The adhesive composition for dermal patch as claimed in claim 8 or 9, wherein the content of the polymer compound having high affinity for the polyhydric alcohol is from 0.01 to 20 mass % based on the entire amount of the composition.

11. The adhesive composition for dermal patch as claimed in claim 1, which comprises diclofenac sodium as a pharmaceutically active ingredient.

12. The adhesive composition for dermal patch as claimed in claim 1, which comprises capsaicin as a pharmaceutically active ingredient.

13. A process for producing an adhesive composition for dermal patch, the adhesive composition comprising, as essential components, (A) a (meth)acrylic acid-base polymer having repeating units represented by formulae (1) and (2): 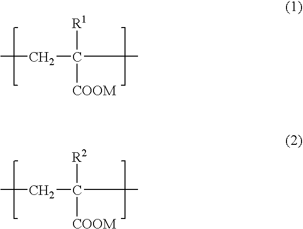
wherein R¹ and R² each independently represents a hydrogen atom or a methyl group and M represents NH₄⁺ or an alkali metal, with a ratio of (1)/(2) being in a range from 100/0 to 90/10 (by mol), (B) water, (C) a polyhydric alcohol and (D) an aluminum compound and comprising, if desired, (E) a polymer compound having high affinity for the polyhydric alcohol, with the content of (B) water being from 5 to 30 mass % above,
wherein the process comprises mixing (A) the (meth)acrylic acid-base polymer and a solution of (C) the polyhydric alcohol in (B) water to give a water concentration of 50% or more in the total mass thereof, and then adding and mixing the remaining ingredients (C) the residual polyhydric alcohol, (D) the aluminum compound and if desired, (E) the polymer compound to adjust the water concentration to a range of 5 to 30%.

14. The adhesive composition for dermal patch as claimed in claim 2, which comprises diclofenac sodium as a pharmaceutically active ingredient.

15. The adhesive composition for dermal patch as claimed in claim 2, which comprises capsaicin as a pharmaceutically active ingredient.

16. The adhesive composition for dermal patch as claimed in claim 3, which comprises diclofenac sodium as a pharmaceutically active ingredient.

17. The adhesive composition for dermal patch as claimed in claim 3, which comprises capsaicin as a pharmaceutically active ingredient.

18. The adhesive composition for dermal patch as claimed in claim 4, which comprises diclofenac sodium as a pharmaceutically active ingredient.

19. The adhesive composition for dermal patch as claimed in claim 4, which comprises capsaicin as a pharmaceutically active ingredient.
